(19) United States
(12) Patent Application Publication
(10) Pub. No.: US 2021/0332615 A1
(43) Pub. Date: Oct. 28, 2021

(54) SAFETY DEVICE FOR PROTECTION OF INFANT

(71) Applicant: Jae Hwa KANG, Daegu (KR)

(72) Inventor: Jae Hwa KANG, Daegu (KR)

(21) Appl. No.: 16/472,984

(22) PCT Filed: Jan. 10, 2019
(86) PCT No.: PCT/KR2019/000374

§ 371 Date: Jun. 24, 2019

(30) Foreign Application Priority Data
Jan. 31, 2018 (KR) 10-2018-0011795

(51) Int. Cl. E05B 65/00; E05B 65/46

(52) U.S. Cl. CPC E05B 65/0014; E05B 65/46

(57) ABSTRACT

A safety device for infant protection includes a body having circular holes on both sides and a bent part in the center thereof to be bent at different angles, which is provided with a reinforcing wall formed with a predetermined height around the entire periphery thereof. Two knobs, each having a flat bottom surface and a screw rod composed of an idle part and a male screw at a predetermined length and projected from the center portion. An outer diameter of the screw rod is larger than a diameter of the circular hole while a diameter of the idle part is smaller than the diameter of the circular hole, whereby the knob can freely rotate without escaping and being disassembled from the circular hole when the idle part of the screw rod is inserted into the circular hole.

### TECHNICAL FIELD

The present invention relates to a safety device for protection of an infant that can artificially control opening and closing of a drawer type storage closet such as a chest of drawers or a door of any furniture in a hinged or sliding mode, and has a simple structure while not being opened at all by young infants, thereby preventing occurrence of various accidents often suffered by infants.

### BACKGROUND ART

A storage closet used in the home is well known to be classified into drawer, sliding door or hinged type cabinets. The drawer type cabinet usually has a two-stage or multi-stage configuration such that a drawer is pulled forward to be opened and pushed backward to be closed.

The sliding door type refers to a manner of opening and closing a door in lateral sides and has a configuration of riding a door rail in any typical furniture to be opened and closed while sliding in left and right directions.

The hinged door type refers to a manner of opening and closing a door by pushing and pulling the door since one side of the door is mounted on a door frame by hinges.

However, surrounding environments and objects including conventional cabinets having such configurations as described above are substantially subjects of curiosity in view of infants who still crawl or start toddling as poor toddlers. Therefore, when the infant attempts to wake up in a state of supporting their weight on furniture while touching and pulling the same, fingers or toes of the infant may be bumped and hurt by the drawer, hinged door or sliding door being opened and closed, or the infant often falls and is injured. In serious cases, the infant may be trapped underneath the furniture which has fallen over.

Meanwhile, in order to overcome the above problems, different ideas such as Korean Patent Laid-Open Publication No. 10-2015-0076563, Korean Patent Laid-Open Publication No. 10-2015-0089210, Korean Utility Model Registration No. 20-0527214 and Korean Utility Model Registration No. 20-0475948, or the like, have been introduced.

However, Korean Patent Laid-Open Publication Nos. 10-2015-0076563 and 10-2015-0089210 described furniture integrally fabricated with a safety device by improving an original structure of the furniture, hence entailing a problem of not being applicable unless the above integral fabrication is implemented during manufacture of the furniture. Further, Korean Utility Model Registration Nos. 20-0428214 and 20-0475948 have an advantage of mounting a safety device on the furniture in use, however, involve a complicated configuration and poor appearance after installation. Moreover, Korean Utility Model Registration No. 20-0428214 has entailed a problem in the configuration wherein the safety device is readily detached from the furniture.

### DISCLOSURE

### Technical Problem

Accordingly, the present invention has been proposed to solve such different problems of the prior art described above, in particular, an object of the present invention is to provide an infant safety device applicable to sliding type furniture and hinged type furniture as well as drawer type furniture, that is, any kind of opening-closing systems in household appliances.

Further, another object of the present invention is to provide an infant safety device with maximum safety, which adopts a simple locking and unlocking mechanism having an extremely simple configuration and being rotatably locked and unlocked like a screw, as well as a coupling manner unable to be operated by force of an infant.

### Technical Solution

An infant safety device of the present invention may include:

a body 1 having circular holes 11 on both sides and a bent part 12 in the center thereof to be bent at different angles, which is provided with a reinforcing wall 14 formed with a predetermined height around the entire periphery thereof; two knobs 2, each of which has a flat bottom surface and includes a screw rod 21 composed of an idle part 21a and a male screw 21b at a predetermined length and projected from the center portion, wherein an outer diameter of the screw rod 21 is larger than a diameter of the circular hole 11 while a diameter of the idle part 21a is smaller than the diameter of the circular hole 11, whereby the knob 2 can freely rotate without escaping and being disassembled from the circular hole 11 when the idle part 21a of the screw rod 21 is inserted into the circular hole 11; and two fixing plates 3, each of which includes a bonding part 31 adhered to a release sheet 31′ at a bottom surface thereof and a boss 32 formed with a predetermined height along with a thread hole 32′ in the center of a top surface of the fixing plate 3, whereby the screw rod 21 can be coupled in the thread hole 32′.

### Advantageous Effects

According to the present invention with such configurations as described above, the body may be used in a horizontal state or by bending the body at 90° about the bent part. Therefore, irrespective of types of furniture such as sliding type or hinged type furniture as well as drawer type furniture, the inventive device may be easily-mounted and used on the furniture. Further, a locking method used herein is to rotate the knob so that the device will, never be unlocked even if young children or infants touch or pull the knob. Moreover, even though a young infant intends to forcibly rotate the knob, the knob cannot be turned and opened by force of the infant, thereby-achieving effects of exceptional safety.

### DESCRIPTION OF DRAWINGS

FIG. 1 is a perspective view illustrating one embodiment of the present invention.

FIG. 2 is an exploded perspective view illustrating one embodiment of the present invention.

FIG. 3 is a longitudinal cross-sectional view illustrating one embodiment of the present invention.

FIG. 4 is a longitudinal cross-sectional view illustrating one embodiment of the present invention, wherein the inventive device is shown in a partially exploded state.

FIG. 5 is a perspective view illustrating a chest of drawers, which shows a state of using the inventive device.

FIG. 6 is a transverse cross-sectional view illustrating a state of using the inventive device.

### BEST MODE

According to the most preferred embodiment of the present invention, there is provided an infant safety device of the present invention, which includes: a body 1 having circular holes 11 on both sides and a bent part 12 in the center thereof to be bent at different angles, which is provided with a reinforcing wall 14 formed with a predetermined height around the entire periphery thereof;

two knobs 2, each of which has a flat bottom surface and includes a screw rod 21 composed of an idle part 21a and a male screw 21b at a predetermined length and projected from the center portion, wherein an outer diameter of the screw rod 21 is larger than a diameter of the circular hole 11 while a diameter of the idle part 21a is smaller than the diameter of the circular hole 11, whereby the knob 2 can freely rotate without escaping and being disassembled from the circular hole 11 when the idle part 21a of the screw rod 21 is inserted into the circular hole 11; and

two fixing plates 3, each of which includes a bonding part 31 adhered to a release sheet 31′ at a bottom surface thereof and a boss 32 formed with a predetermined height along with a thread hole 32′ in the center of a top surface of the fixing plate 3, whereby the screw rod 21 can be coupled in the thread hole 32′.

### Preferred Embodiment of Invention

The present invention is intended to prevent accidents which often occur among infants in conjunction with furniture, and provides a safety device with very simple configurations to be quickly and easily manufactured and assembled, which is applicable to various types of furniture such as drawer type, sliding type and hinged type furniture, and is easy and convenient to operate while not being opened by force of a child or infant so as to maximize safety and reliability. In this regard, with respect to the accompanying drawings, the following description will be given.

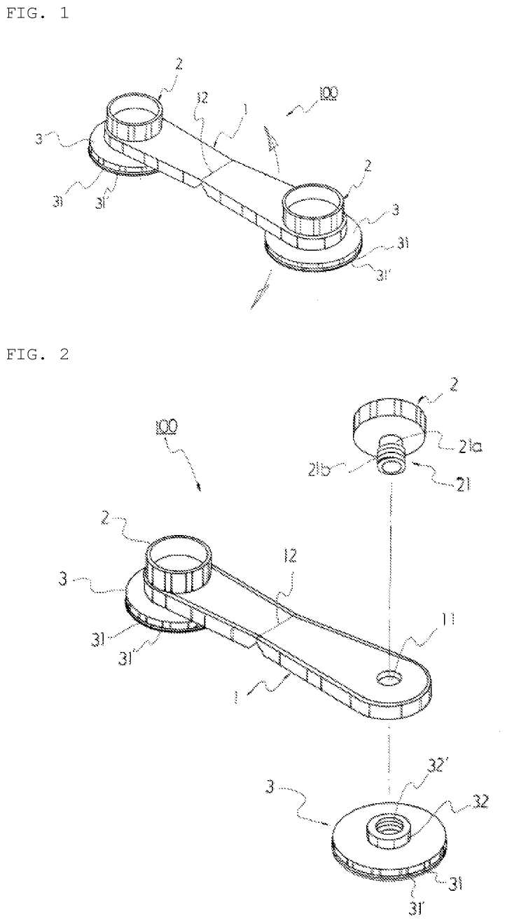

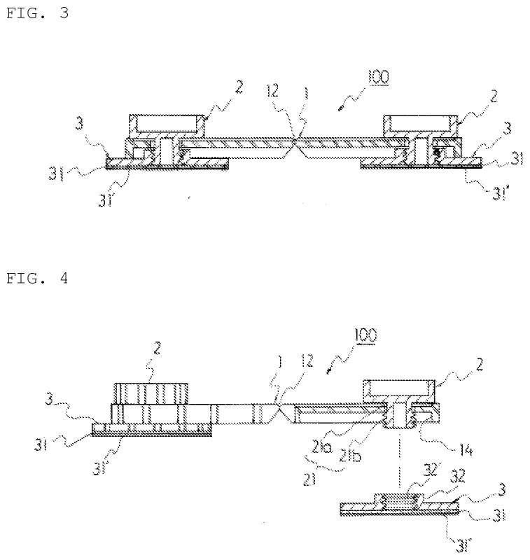

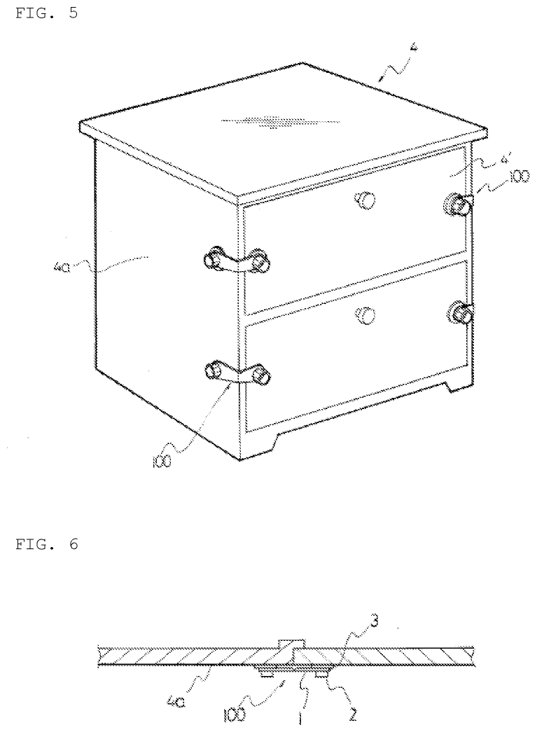

Referring to the accompanying drawings, that is, FIGS. 1 to 6, FIG. 1 is a perspective view illustrating the present invention, FIG. 2 is an exploded perspective view illustrating the present invention in a partially exploded state, FIG. 3 is a longitudinal cross-sectional view illustrating the present invention m an assembled state, FIG. 4 is a longitudinal cross-sectional view illustrating the present invention in a partially exploded state, and FIGS. 5 and 6 illustrate a state of using the present invention.

Referring to FIGS. 1 to 6, the present invention will be described as follows.

The safety device 100 for infant protection (“infant safety device”) may be formed using a synthetic resin material and may include three major components such as a body 1, a knob 2 and a fixing plate 3.

The body 1 is formed in a long band shape and includes circular holes 11 at both sides thereof.

Further, a bent part 12 is provided in the center of the body 1 and may be used by bending the body 1 at various angles to a horizontal direction. Therefore, when installing the furniture as shown in FIG. 5, a furniture wall 4a and a drawer 4′ may be simultaneously coupled and locked by bending the body 1 at a right angle to the horizontal direction in order to prevent an infant from opening the same. On the other hand, upon loosening of the knob 2 in any one of the furniture wall 4a and the drawer 4′, the drawer may be freely opened and closed, thereby enabling storage of various items in the drawer. Further, as shown in FIG. 6, according to characteristics in structures of the furniture such as hinged door type furniture, sliding door type furniture, etc., the body 1 may be mounted and used in a straight line form. Further, other than the straight line form or a right angle form, independently of types and forms of the furniture, the body 1 may be conveniently applied at different angles. Further, there is provided a reinforcing wall 14 with a predetermined height around the periphery of the body 1 in order to remarkably increase strength of the infant safety device 100.

The knob 2 may have a bottom surface in a flat plane form, as well as a screw rod 21 consisting of an idle part 21a and a male screw 21b in the center of the bottom surface, which is projected with a predetermined length from the center portion. Further, when the idle part 21a of the screw rod 21 is inserted into the circular hole 11, the knob 2 should freely rotate while not escaping from the circular hole 11 so as to ensure improved safety and convenience in use thereof. For these purposes, the present invention includes forced assembly of the screw rod 21 of the mold-injected knob 2 into the circular hole 11 in a condition wherein the body 1 is not yet chilled immediately after molding the body 1 in a molding process of the body 1 and the knob 2, whereby the body 1 and the knob 2 may be suitably assembled without difficulty so as to afford an integrated structure wherein the knob 2 does not escape from the body 1 during use.

Meanwhile, since the infant safety device 100 of the present invention is formed using a synthetic resin material, the screw rod 21 may be forcedly coupled to and assembled in the circular hole 11 when the circular hole 11 is formed to have a diameter with a smaller tolerance than an outer diameter of the male screw 21b of the screw rod 21. Further, after completing assembly, the screw rod 21 is not easily separated from the circular hole 11.

As such, after inserting the screw rod 21 provided on the knob 2 into the circular hole 11 of the body 1, this would never be disassembled by itself unless external force is applied since the male screw 21b is formed to have an outer diameter with a larger tolerance than the circular hole 11. Accordingly, the idle part 21a formed on top of the male screw 21b and having a smaller diameter than the circular hole 11 can freely rotate within the circular hole 11.

The fixing plate 3 may be provided with a bonding part 31 adhered to a release sheet 31′ at a bottom surface thereof, and may include a boss 32 formed with a predetermined height along with a thread hole 32′ in the center of a top surface of the fixing plate 3, whereby the screw rod 21 can be coupled in the thread hole 32′.

The present invention configured as described has been substantially invented in full consideration of characteristics of young infants. Especially, considering a fact that the young infant may easily and instinctively act to pull or push but is unable to rotate something while holding the same, in addition to the force of an infant, a coupling manner of rotating the knob 2 equipped with the screw rod 21 has been developed, thereby definitely achieving excellent safety.

Such an infant safety device 100 of the present invention is fabricated by assembling the screw rod 21 of the knob 2 in the circular holes 11 at both sides of the body 1, and then, coupling and assembling the fixing plate 3 in the male screw 21b at an end of the screw rod 21, which in turn may be packaged and distributed. Therefore, users who purchase the inventive device will be able to easily use the same by simply mounting the device on any furniture.

In other words, when using the infant safety device 100 of the present invention on the furniture, first of all, dust or impurities should be removed from a portion to which the bonding part 31 is attached, for example, a door or a surface of a drawer, etc. Then, the knob 2 and the fixing plate 3 are assembled in the body 1, followed by removing the release sheet 31′. Thereafter, as shown in FIGS. 5 and 6, the installation is completed by mounting the device on the furniture. As soon as the installation is completed, the furniture equipped with the inventive device is securely locked and cannot be unlocked by young infants.

Further, under the state described above, when the drawer or the like needs to be opened, the male screw 21b escapes from the thread hole 32′ of the fixing plate 3 by rotating the knob 2 attached at the door or drawer side of the furniture in a counterclockwise direction, which in turn separates the knob 2 from the fixing plate 3. At this time, the drawer or the door of the furniture may be freely opened.

Meanwhile, when it is intended to prevent the infant from opening the drawer or the door of the furniture, the device may be locked by assembling the same in reverse order of the unlocking process.

In other words, as mentioned above, the infant safety device 100 of the present invention is usually under management such as storage, distribution and installation thereof on furniture in a state wherein three major components such as the body 1, the knob 2 and the fixing plate 3 have already been assembled, whereby installation may be very quickly and exactly performed. Further, after installation, the device may be easily unlocked by a simple operation of rotating the knob 2 in the counterclockwise direction. In addition, the device may be easily locked by a simple operation such that the male screw 21b provided in the center of the knob 2 at one side of the body 1 is coupled in the thread hole 32′ formed in the center of the fixing plate 3 and, since the knob 2 is not rotated and the device cannot be unlocked with force of a young infant, excellent handling and safety may be attained.

As described above, according to the present invention, the body 1 may be freely adjusted in a horizontal direction in a straight line form and at a right angle or at different angles, and therefore, may be desirably regulated and mounted on any kind of furniture. Further, the present invention is characterized in that locking and unlocking may be implemented by turning the knob 2 in a screw-thread manner. Accordingly, the scope of the present invention to be protected is not particularly limited to the above described embodiments and, even if the configuration is somewhat changed, various modifications and embodiments would be possible within the purpose and spirit of the present invention.

1. A safety device for infant protection, comprising:
a body having circular holes at opposite sides and a bent part in a center thereof to be bent at different angles, which is provided with a reinforcing wall formed with a predetermined height around an entire periphery thereof,
two knobs, each of which has a flat bottom surface and includes a screw rod composed of an idle part and a male screw at a predetermined length and projected from a center portion thereof, wherein an outer diameter of the screw rod is larger than a diameter of the circular hole while a diameter of the idle part is smaller than the diameter of the circular hole, whereby the knob can freely rotate without escaping and being disassembled from the circular hole when the idle part of the screw rod is inserted into the circular hole; and
two fixing plates, each of which includes a bonding part adhered to a release sheet at a bottom surface thereof and a boss formed with a predetermined height along with a thread hole in a center of a top surface of the fixing plate, whereby the screw rod can be coupled in the thread hole.
